(19) United States
(12) Patent Application Publication
(10) Pub. No.: US 2017/0048139 A1
(43) Pub. Date: Feb. 16, 2017

(54) Interconnecting an Overlay Management Control Network (OMCN) to a Non-OMCN

(71) Applicant: Futurewei Technologies, Inc., Plano, TX (US)

(72) Inventors: Zhenjiang Li, San Jose, CA (US); Fangping Liu, San Jose, CA (US)

(21) Appl. No.: 14/827,069

(22) Filed: Aug. 14, 2015

(51) Int. Cl. H04L 12/715; H04L 12/721; H04L 29/12; H04L 12/46

(52) U.S. Cl. CPC H04L 45/64; H04L 12/46; H04L 45/66; H04L 61/103

(57) ABSTRACT

A method implemented in a boundary device located in a first network, the method comprises receiving a first frame from a first node located in a second network, detecting a format of the first frame, wherein the format is compatible with the first node, but is incompatible with a second node located in the first network, converting the first frame to a second frame, wherein the second frame is in a second format that is compatible with the second node, but is incompatible with the first node, and transmitting the second frame towards the second node. A method comprises receiving an overlay management control network (OMCN) frame from a source node located in an OMCN, converting the OMCN frame to an Ethernet frame so that the converting is transparent to a non-OMCN, and transmitting the Ethernet frame towards a destination node located in the non-OMCN.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Network management refers to the operation, administration, maintenance, and provisioning (OAMP) of a network. Operation refers to keeping the network and its services running. Administration refers to monitoring and assigning resources. Maintenance refers to repairs, upgrades, and replacements, for instance replacing a router. Provisioning refers to configuring resources to support services.

There are two main types of network management, out-of-band management and in-band management. A physical management network employs out-of-band management and is therefore referred to as an out-of-band management network (OBMN). The physical management network manages a data network and must be built, wired, and managed separately from the data network. Typically, one must manually provision a management port of a switch in the data network in order to access and manage the switch. The physical management network requires network expertise during deployment, cannot be automated, and causes extra capital expenditure and operating expenditure.

An overlay management control network (OMCN) employs in-band management and is therefore referred to as an in-band management network (IBMN). The OMCN eliminates the need for a separate physical management network and thus the need to manually build, wire, and manage it. Instead of having a separate physical management network, the OMCN is a virtualized overlay management network that uses in-band communication and shares the same physical media with a data network. In-band communication refers to transmitting and receiving metadata and control information within the same band or channel as user data. The OMCN is implemented in layer 2, the data link layer of the Open Systems Interconnected (OSI) model. Operation of the OMCN requires no configuration, but is instead automated. In other words, devices within the data network have plug and play capability. In addition, the OMCN is self-organizing because its operation does not require human involvement. For those reasons, the OMCN reduces capital expenditure and operating expenditure.

### SUMMARY

In one embodiment, the disclosure includes a method implemented in a boundary device located in a first network, the method comprising receiving a first frame from a first node located in a second network, detecting a format of the first frame, wherein the format is compatible with the first node, but is incompatible with a second node located in the first network, converting the first frame to a second frame, wherein the second frame is in a second format that is compatible with the second node, but is incompatible with the first node, and transmitting the second frame towards the second node.

In another embodiment, the disclosure includes a method comprising receiving an overlay management control network (OMCN) frame from a source node located in an OMCN, converting the OMCN frame to an Ethernet frame so that the converting is transparent to a non-OMCN, and transmitting the Ethernet frame towards a destination node located in the non-OMCN.

In yet another embodiment, the disclosure includes an apparatus located in a first network and comprising a receiver configured to receive, from a first source node located in the first network, a first frame associated with the first network, and receive, from a second source node located in a second network, a second frame associated with the second network, a processor coupled to the receiver and configured to convert the first frame to a third frame associated with the second network, and convert the second frame to a fourth frame associated with the first network, and a transmitter coupled to the processor and configured to transmit, towards a first destination node located in the second network, the third frame, and transmit, towards a second destination node located in the first network, the fourth frame.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a group of interconnected networks.

FIG. 2 is a schematic diagram of a group of interconnected networks according to an embodiment of the disclosure.

FIG. 3 is a schematic diagram of an Ethernet II frame.

FIG. 4 is a schematic diagram of a method for converting the Ethernet frame in FIG. 3 to an overlay management control network (OMCN) frame according to an embodiment of the disclosure.

FIG. 5 is a schematic diagram of a method for converting the OMCN frame in FIG. 4 to the Ethernet II frame in FIGS. 3-4 according to an embodiment of the disclosure.

FIG. 6 is a flowchart illustrating a method of converting a first frame to a second frame according to an embodiment of the disclosure.

FIG. 7 is a flowchart illustrating a method of converting an OMCN frame to an Ethernet frame according to an embodiment of the disclosure.

FIG. 8 is a schematic diagram of a network device according to an embodiment of the disclosure.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

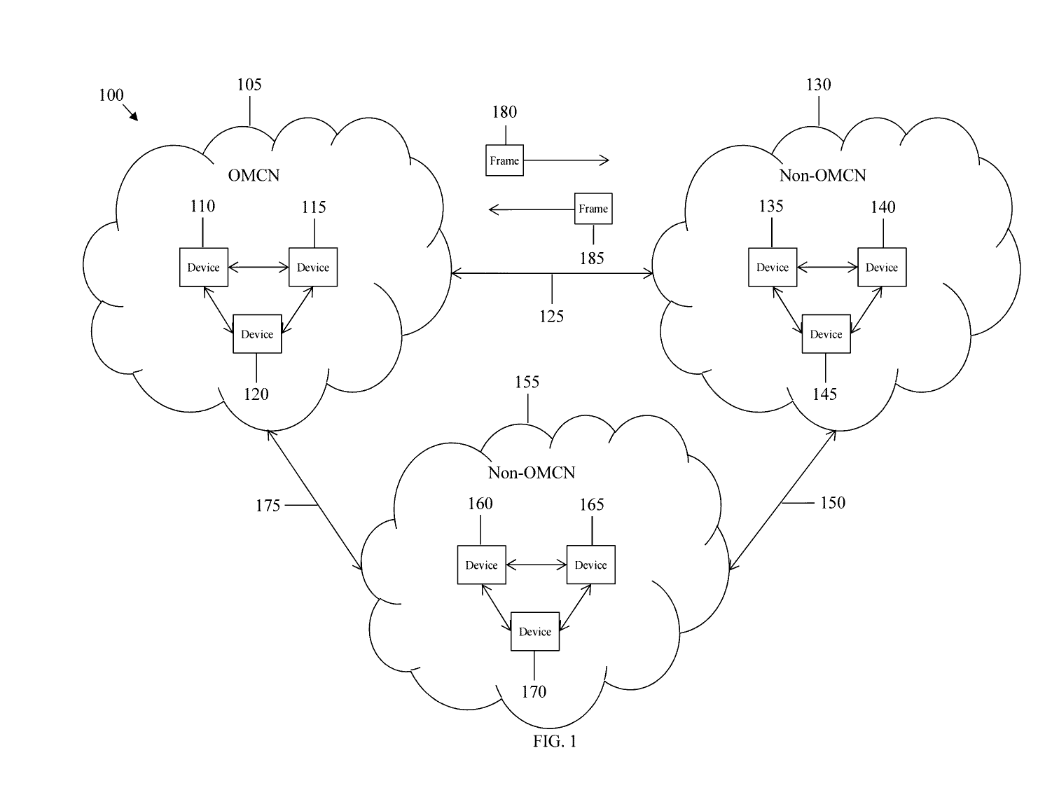

FIG. 1 is a schematic diagram of a group 100 of interconnected networks. The group 100 comprises an overlay management control network (OMCN) 105, a first non-OMCN 130, and a second non-OMCN 155 coupled among each other via channels 125, 150, 175. Though only one OMCN and two non-OMCNs are shown, the group 100 may comprise any number of OMCNs and non-OMCNs. For purposes of this disclosure, the OMCN 105 may be referred to as an internal network, and the non-OMCNs 130, 155 may be referred to as existing networks or external networks. The components of the group 100 may be arranged as shown or in any other suitable manner.

The OMCN 105 comprises devices 110, 115, 120 coupled among each other. The devices 110, 115, 120 are servers, switches, routers, and other suitable devices. Though only three devices are shown, the OMCN 105 may comprise any number of devices. The OMCN is implemented as described above and as described in United States Patent Application Publication number US 2015/0139036 titled “Method and System for an Overlay Management Control Network” by Fangping Liu, which is incorporated by reference.

The non-OMCN 130 is implemented as any suitable in-band management network or out-of-band management network. The non-OMCN 130 employs Ethernet as defined in The Institute of Electrical and Electronics Engineers (IEEE) 802.3, which is incorporated by reference. For instance, the non-OMCN 130 uses Ethernet II frames or other suitable frames. Alternatively, the non-OMCN 130 employs another suitable standard. The non-OMCN 130 comprises devices 135, 140, 145 coupled among each other. The devices 135, 140, 145 are servers, switches, routers, and other suitable devices. Though only three devices are shown, the non-OMCN 130 may comprise any number of devices.

The non-OMCN 130 is implemented as any suitable in-band management network or out-of-band management network. The non-OMCN 130 employs Ethernet as defined in IEEE 802.3. For instance, the non-OMCN 130 uses Ethernet II frames or other suitable frames. Alternatively, the non-OMCN 130 employs another suitable standard. The non-OMCN 155 comprises devices 160, 165, 170 coupled among each other. The devices 160, 165, 170 are servers, switches, routers, and other suitable devices. Though only three devices are shown, the non-OMCN 155 may comprise any number of devices.

The channels 125, 150, 175 are any channels suitable for communicating data among the OMCN 105, the non-OMCN 130, and the non-OMCN 155. For instance, the channels 125, 150, 175 are optical fibers, telephone lines, coaxial cables, portions of the electromagnetic spectrum, or combinations thereof. Thus, the channels 125, 150, 175 are physical media, logical connections, or both.

An issue arises when, for instance, the OMCN 105 needs to access services in the non-OMCNs 130, 155 because the OMCN 105 has different protocols from the non-OMCNs 130, 155. For instance, if the OMCN 105 needs to access an email service in the non-OMCN 130, then the OMCN 105 may send to the non-OMCN 130 a request for an email via a frame 180. The device 110, 115, 120 in the OMCN 105 that generates and originally transmits the frame 180 is referred to as a source node. The device 135, 140, 145 in the non-OMCN 130 that the frame 180 is intended for and that last receives the frame 180 is referred to as a destination node. However, the non-OMCN 130 may not be able to properly parse or decode the frame 180 because the frame 180 may comprise headers and other control data associated with management of the OMCN 105 that the non-OMCN 130 may not understand or be compatible with. Similarly, the non-OMCN 130 may send to the OMCN 105 an email via a frame 185, but the OMCN 105 may not be able to properly parse or decode the frame 185 because the frame 185 may comprise headers and other control data associated with management of the non-OMCN 130 that the non-OMCN 105 may not understand or be compatible with. Accordingly, there is a need for the OMCN 105 to interconnect to the non-OMCNs 130, 155 so that the OMCN 105 may properly communicate with the non-OMCNs 130, 155.

Disclosed herein are embodiments for interconnecting an OMCN to a non-OMCN. Specifically, the disclosed embodiments comprise at least two aspects. A first aspect comprises a set of rules for converting frames and packets between an OMCN and a non-OMCN. The terms “frame” and “packet” and their derivatives may be used interchangeably. A second aspect comprises a set of encapsulation formats for implementing the conversion. The interconnection permits a seamless deployment of an OMCN among one or more non-OMCNs. The interconnection is transparent to the non-OMCNs, which may view the addition of the OMCN as a planned expansion. In addition, the interconnection enables devices inside the OMCN to access services outside the OMCN and inside the non-OMCNs. Those services include Dynamic Host Configuration Protocol (DHCP), software-defined networking (SDN), email, File Transfer Protocol (FTP), Telnet, and other suitable services. Finally, the interconnection enables devices outside the OMCN and inside the non-OMCNs to access services inside the OMCN. Those services include remote monitoring, debugging, and other suitable services.

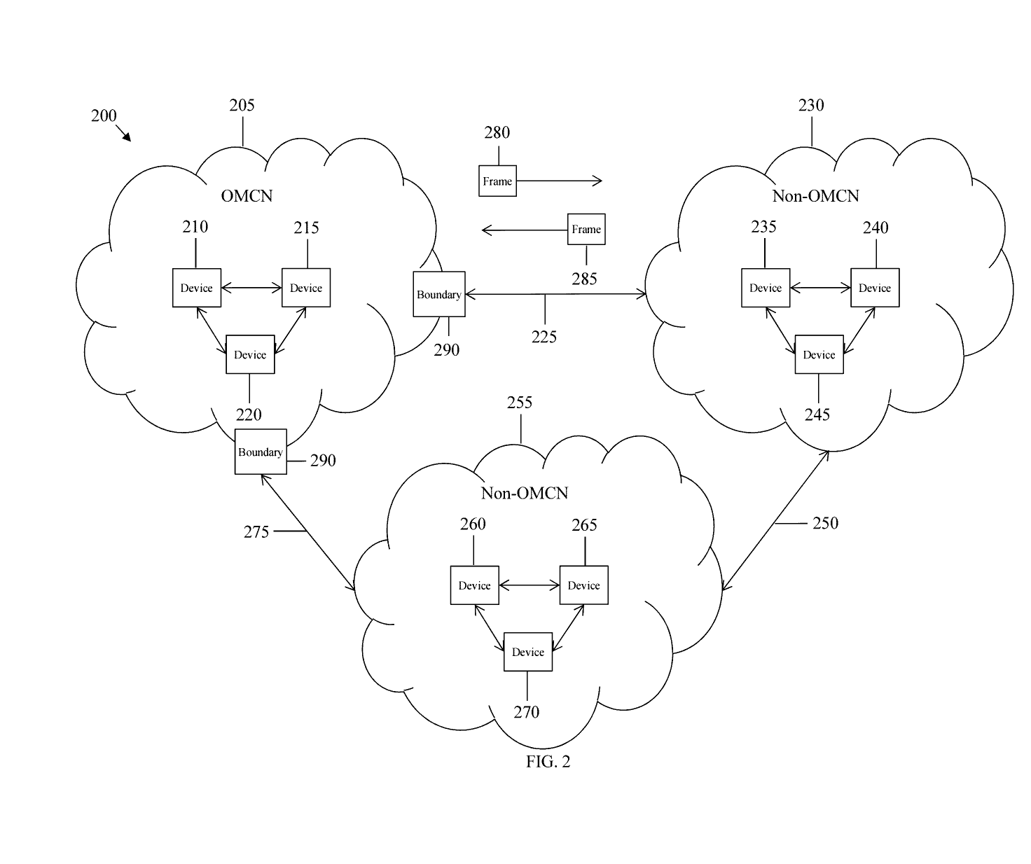

FIG. 2 is a schematic diagram of a group 200 of interconnected networks according to an embodiment of the disclosure. The group 200 comprises an OMCN 205, a first non-OMCN 230, and a second non-OMCN 255 coupled among each other via channels 225, 250, 275. The OMCN 205, the non-OMCN 230, the non-OMCN 255, and the channels 225, 250, 275 are similar to the OMCN 105, the non-OMCN 130, the non-OMCN 155, and the channels 125, 150, 175, respectively. Thus, the devices 210, 215, 220 are similar to the devices 110, 115, 120, respectively; the devices 235, 240, 245 are similar to the devices 135, 140, 145, respectively; and the devices 260, 265, 270 are similar to the devices 160, 165, 170, respectively. However, unlike the OMCN 105, the OMCN 205 comprises a boundary 290 that couples to the non-OMCNs 230, 255.

The boundary 290 is any suitable computer, server, router, switch, or other device. The boundary 290 is a physical device, a logical device, or a combination of both. Though the boundary 290 is shown as a single component of the OMCN 205, the boundary 290 may be made up of multiple physical devices, logical devices, or combinations of both. The boundary 290 exists at every point in the OMCN 205 where the OMCN 205 couples to the non-OMCNs 230, 255. Thus, the boundary 290 implements an interconnection between the OMCN 205 on the one hand and the non-OMCNs 230, 255 on the other hand. The boundary 290 has two interfaces, an internal interface (not shown) coupled to the OMCN 205 and an external interface (not shown) coupled to the non-OMCNs 230, 255. Though the boundary 290 is shown in the OMCN 205, the boundary 290 may exist at other suitable locations. For instance, the boundary 290 may exist in the channels 225, 250, 275.

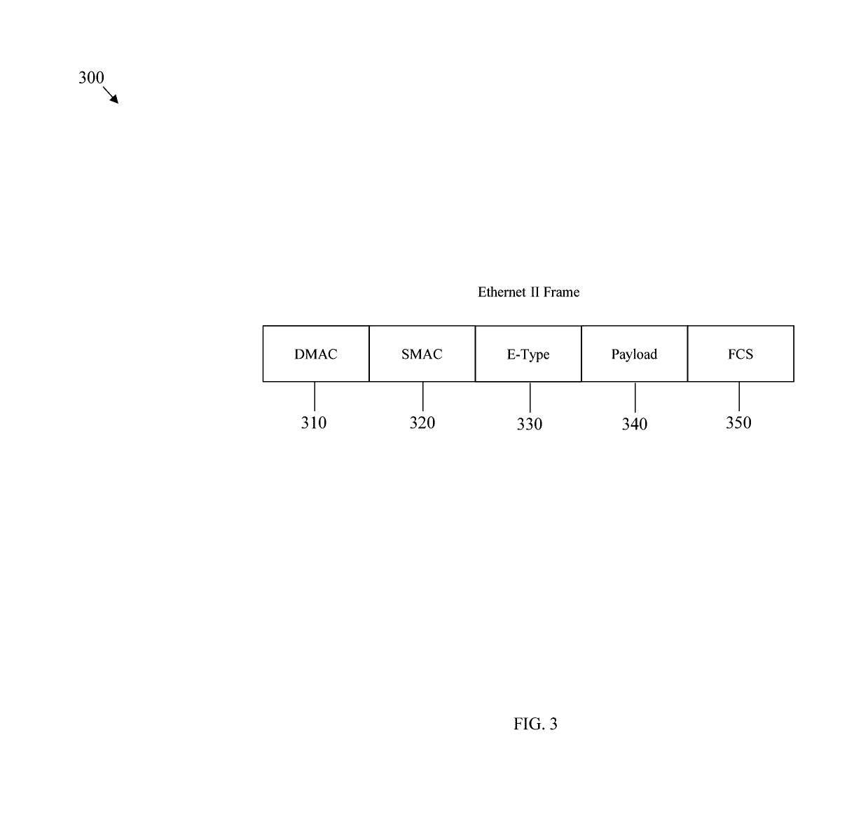

FIG. 3 is a schematic diagram of an Ethernet II frame 300. The Ethernet II frame 300 comprises a destination media access control (DMAC) field 310, a source media access control (SMAC) field 320, an EtherType (E-Type) field 330, a payload 340, and a frame check sequence (FCS) field 350. The Ethernet II frame 300 is about 64 to about 1,518 bytes. The fields of the Ethernet II frame 300 may be arranged as shown or in any other suitable manner.

The DMAC field 310 is the first field in the Ethernet II frame 300, identifies a DMAC address of a destination node that the Ethernet II frame 300 is intended for, and is about six bytes. The SMAC field 320 is the second field in the Ethernet II frame 300, identifies an SMAC address of a source node that the Ethernet II frame 300 originated from, and is about six bytes. The E-Type field 330 is the third field in the Ethernet II frame 300, identifies an upper layer protocol encapsulating the data in the Ethernet II frame 300, and is about two bytes. The payload 340 is the fourth field in the Ethernet II frame 300, comprises data that are the fundamental purpose of the Ethernet II frame 300, and is about 46 to about 1,500 bytes. The FCS field 350 is the fifth and last field in the Ethernet II frame 300, comprises a cyclic redundancy check (CRC) to detect any in-transit corruption of data, may also be referred to as a CRC checksum field, and is about four bytes.

As described above, there are two aspects of the disclosed embodiments. A first aspect comprises a set of rules for converting frames and packets between the OMCN 205 and the non-OMCNs 230, 255. For instance, the non-OMCNs 230, 255 might use the Ethernet II frame 300 within their networks. To travel from the non-OMCNs 230, 255 to the OMCN 205, the Ethernet II frame 300 must be converted to a format that the OMCN 205 understands and is compatible with. A first rule is that the conversion must be bi-directional. In other words, frames and packets are converted when they enter and exit the boundary 290. A second rule is that the conversion occurs at only the boundary 290. In other words, the conversion does not occur deeper within the OMCN 205; within one of the channels 225, 250, 275; or within the non-OMCNs 230, 255. This rule makes the conversion transparent to the devices 210, 215, 220 in the OMCN 205; the devices 235, 240, 245 in the non-OMCN 230; and the devices 260, 265, 270 in the non-OMCN 255.

A second aspect of the disclosed embodiments comprises a set of encapsulation formats for implementing the conversion. Encapsulation refers to the process of placing fields from a first frame in a second frame, then adding additional header and control data to the second frame. The disclosed encapsulation formats are compatible with Ethernet and its standards, including IEEE 802.3. To achieve this, OMCN-specific fields are placed inside the Ethernet frame. The disclosed encapsulation formats may also be compatible with other suitable standards.

The OMCN-specific fields include various virtual media access control (VMAC) addresses that are used for frame and packet encapsulation in the OMCN 205. For instance, well-known media access control (WMAC) addresses are allocated for and understood by only the OMCN 205. OMCN media access control (OMAC) addresses are assigned by the devices 210, 215, 220 to uniquely identify themselves inside the OMCN 205. External media access control (EMAC) addresses are typically assigned by manufacturers of network interface controllers (NICs) (not shown) in the devices 235, 240, 245, 260, 265, 270 in the non-OMCNs 230, 255. The EMAC addresses may encode the manufacturers' registered identification numbers, may be referred to as burned-in addresses (BIAs), and uniquely identify the devices 235, 240, 245, 260, 265, 270 in the non-OMCNs 230, 255.

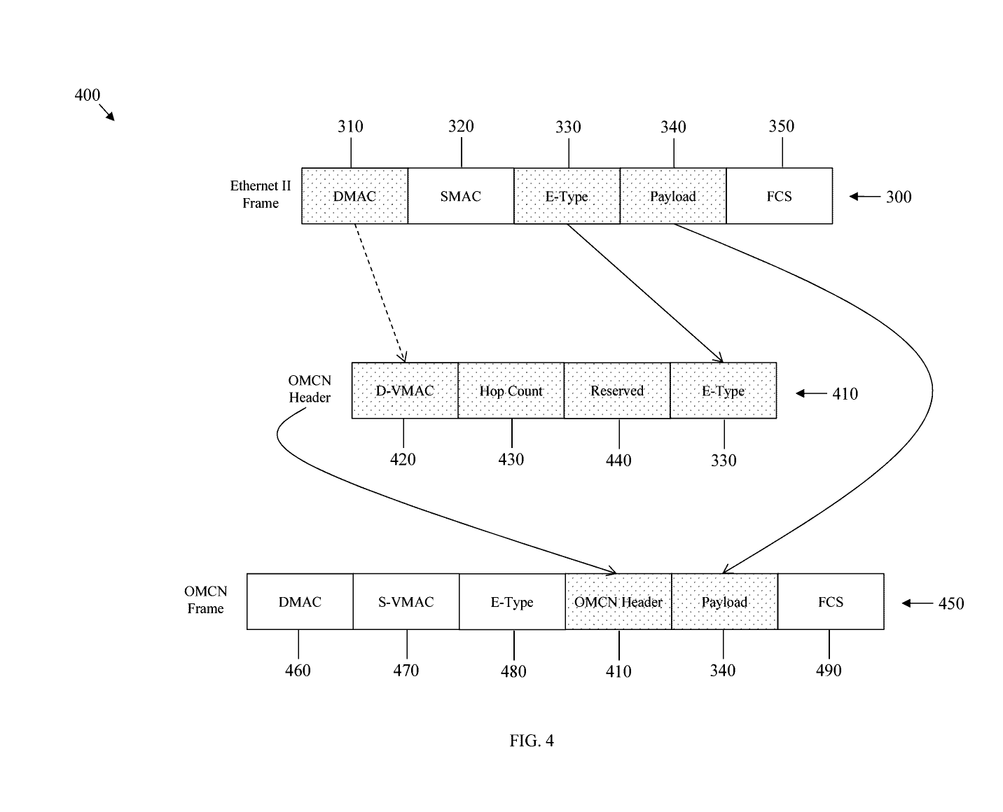

FIG. 4 is a schematic diagram of a method 400 for converting the Ethernet II frame 300 in FIG. 3 to an OMCN frame 450 according to an embodiment of the disclosure. The boundary 290 implements the method when a source node device in one of the non-OMCNs 230, 255 transmits the Ethernet II frame 300 towards a destination node device in the OMCN 205. Though the method 400 illustrates a specific order for conversion, the method 400 may proceed in any suitable order that results in the OMCN frame 450. First, the method 400 begins with the Ethernet II frame 300. The Ethernet II frame 300 is not understandable to, and is incompatible with, the devices 210, 215, 220 in the OMCN 205.

Second, the method 400 forms an OMCN header 410. The OMCN header 410 comprises a destination VMAC (D-VMAC) field 420, a hop count field 430, a reserved field 440, and the E-Type field 330. The OMCN header 410 is about 80 bits. The fields of the OMCN header 410 may be arranged as shown or in any other suitable manner.

The D-VMAC field 420 is the first field in the OMCN header 410; is the same as the DMAC field 310 from the Ethernet II frame 300; and is about 48 bits, or 6 bytes. The hop count field 420 is the second field in the OMCN header 410; is set to a predetermined maximum value N, where N is an integer; and is about 8 bits. The reserved field 440 is the third field in the OMCN header 410, is reserved for any suitable future use, and is about eight bits. Without a designated use, the reserved field 440 may be set to, for instance, 00000000. The E-Type field 330 is the fourth and last field in the OMCN header 410; is from the Ethernet II frame 300; and is about 16 bits, or 2 bytes.

Third, the method 400 forms the OMCN frame 450. The OMCN frame 450 comprises a DMAC field 460, a source VMAC (S-VMAC) field 470, an E-Type field 480, the OMCN header 410, the payload 340, and an FCS field 490. The OMCN frame 450 is a variable number of bits because the payload 340 is a variable number of bits between about 46 to about 1,500 bytes. The fields of the OMCN frame 450 may be arranged as shown or in any other suitable manner.

The DMAC field 460 is the first field in the OMCN frame 450; is set to a predetermined value, for instance WMACO or 03:80:C2:00:00:00; and is about 48 bits. The predetermined value of the DMAC field 460 indicates that the OMCN frame 450 is an OMCN frame that should be handled differently from the Ethernet II frame. The S-VMAC field 470 is the second field in the OMCN frame 450, is the OMAC address of the internal interface of the boundary 290, and is about 48 bits. The E-Type field 480 is the third field in the OMCN frame 450, is set to an EtherType OMCN (ET-OMCN) value assigned by IEEE to the OMCN 205, and is about 16 bits. The OMCN header 410 is the fourth field in the OMCN frame 450, is described above, and is about 80 bits. The payload 340 is the fifth field in the OMCN frame 450, is from the Ethernet II frame 300, and is about 46 to about 1,500 bytes. The FCS field 490 is the sixth field in the OMCN frame 450, comprises a CRC to detect any in-transit corruption of data, and is about 32 bits. The OMCN frame 450 is understandable to, and compatible with, the devices 210, 215, and 220 in the OMCN 205.

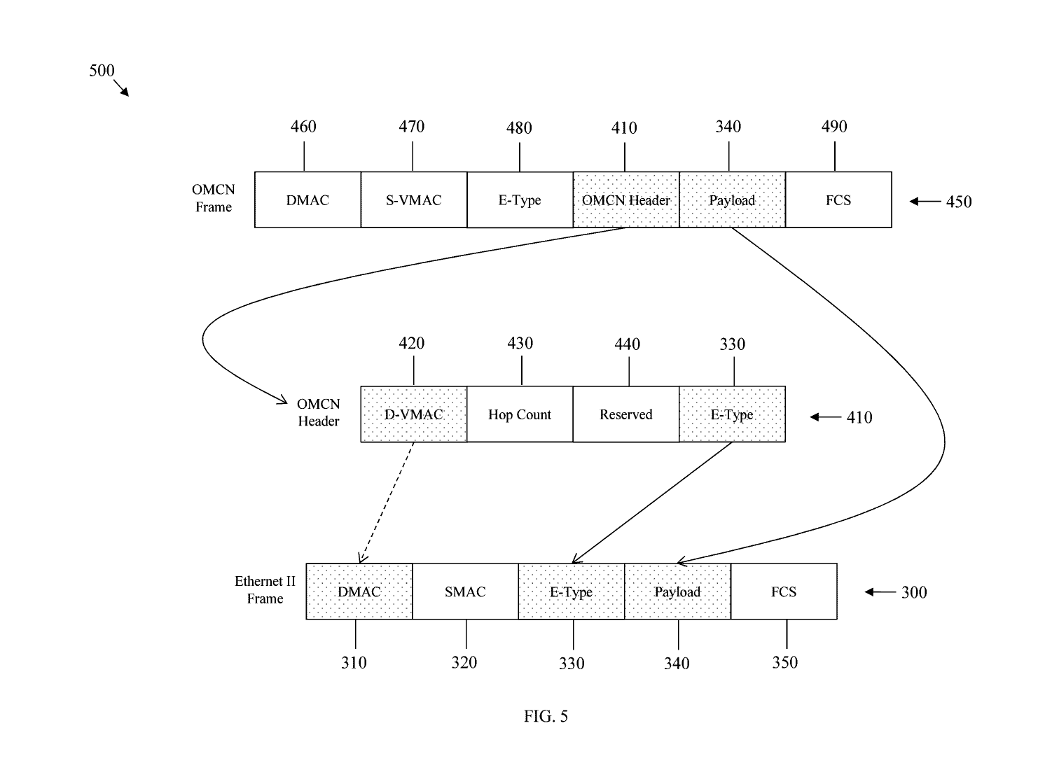

FIG. 5 is a schematic diagram of a method 500 for converting the OMCN frame 450 in FIG. 4 to the Ethernet II frame 300 in FIGS. 3-4 according to an embodiment of the disclosure. The boundary 290 implements the method when a source node device in the OMCN 205 transmits the OMCN frame 450 towards a destination node device in one of the non-OMCNs 230, 255. Though the method 500 illustrates a specific order for conversion, the method 500 may proceed in any suitable order that results in the Ethernet II frame 300.

First, the method 500 begins with the OMCN frame 450. The OMCN frame 450 is not understandable to, and is incompatible with, the devices 235, 240, and 245 in the non-OMCN 230 and the devices 260, 265, 270 in the non-OMCI 255. Second, the method 500 extracts the OMCN header 410 and the payload 340 from the OMCN frame 450. Third, the method 500 extracts the D-VMAC field 420 and the E-Type field 330 from the OMCN header 410.

Fourth, the method 500 forms the Ethernet II frame 300. The Ethernet II frame 300 comprises the DMAC field 310, the SMAC field 320, the E-Type field 330, the payload 340, and the FCS field 350. The DMAC field 310 is the same as the D-VMAC field 420 in the OMCN header 410. The SMAC field 320 is the EMAC address of the external face of the boundary 290. The E-Type field 330 is from the OMCN header 410. The payload 340 is from the OMCN frame 450. The FCS field 350 is generated as described above. As can be seen, the OMCN header 410 is removed. The Ethernet II frame 300 is understandable to, and compatible with, the devices 235, 240, and 245 in the non-OMCN 230 and the devices 260, 265, 270 in the non-OMCI 255.

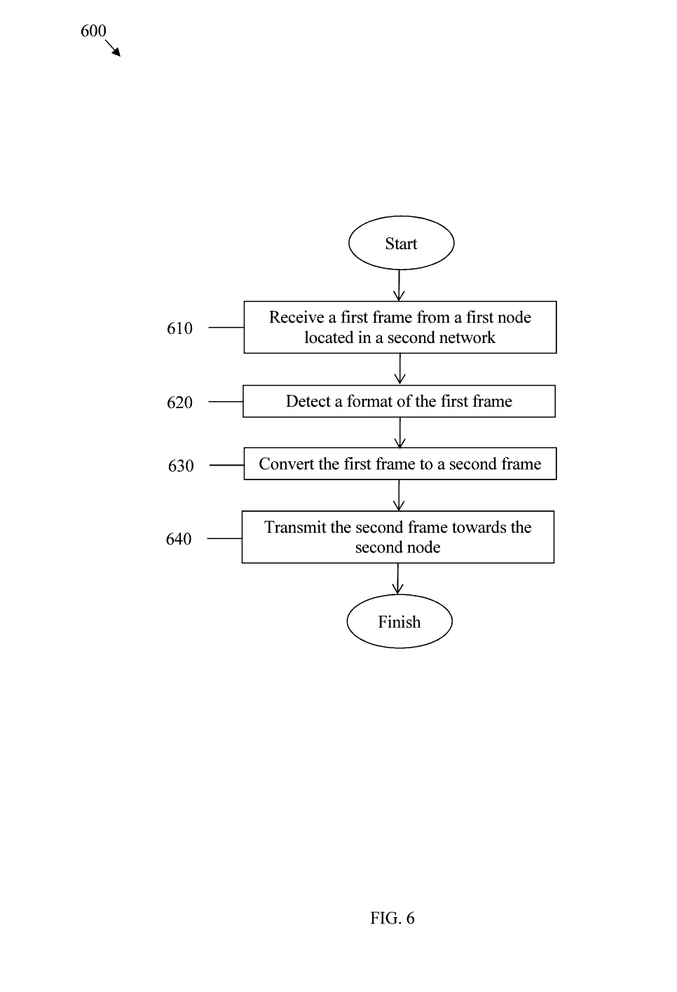

FIG. 6 is a flowchart illustrating a method 600 of converting a first frame to a second frame according to an embodiment of the disclosure. A device, for instance a device in the boundary 290, performs the method 600 when the boundary 290 receives a first frame. At step 610, a first frame from a first node located in a second network is received. For instance, the boundary 290 in the OMCN 205 receives a frame from the device 235 located in the non-OMCN 230. At step 620, a format of the first frame is detected. For instance, the boundary 290 detects that the first frame is the Ethernet II frame 300. The Ethernet II frame 300 is compatible with the device 235, but is incompatible with the device 215 in the OMCN 205. At step 630, the first frame is converted to a second frame. For instance, the boundary 290 converts the Ethernet II frame to the OMCN frame 450. Finally, at step 640, the second frame is transmitted towards the second node. For instance, the boundary 290 transmits the OMCN frame 450 to the device 215.

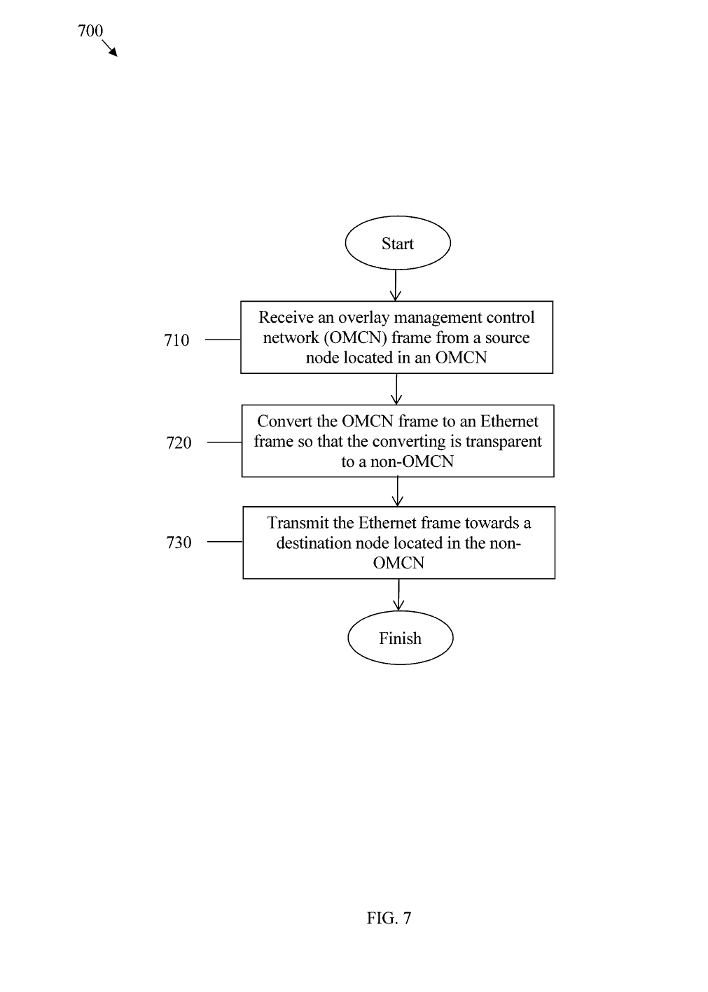

FIG. 7 is a flowchart illustrating a method 700 of converting an OMCN frame to an Ethernet frame according to an embodiment of the disclosure. A device, for instance a device in the boundary 290, performs the method 700 when the boundary 290 receives an OMCN frame. At step 710, an OMCN frame is received from a source node located in an OMCN. For instance, the boundary 290 receives the OMCN frame 450 from the device 215 in the OMCN 205. At step 720, the OMCN frame is converted to an Ethernet frame so that the converting is transparent to a non-OMCN. For instance, the boundary 290 converts the OMCN frame 450 to the Ethernet II frame 300 so that the converting is transparent to the non-OMCN 230. Finally, at step 730, the Ethernet frame is transmitted towards a destination node located in the non-OMCN. For instance, the boundary 290 transmits the Ethernet II frame 300 towards the device 235 in the non-OMCN 230.

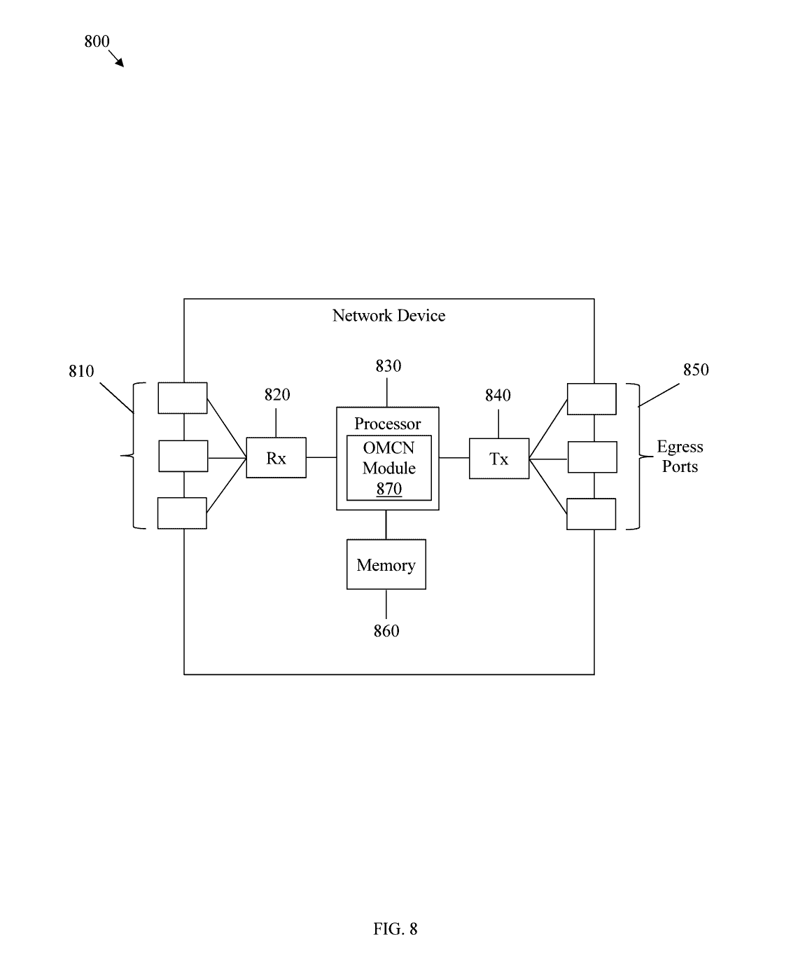

FIG. 8 is a schematic diagram of a network device 800 according to an embodiment of the disclosure. The device 800 is suitable for implementing the disclosed embodiments, including the boundary 290 and the methods 400, 500, 600, 700. The network device 800 comprises ingress ports 810 and receiver units (Rx) 820 for receiving data; a processor, logic unit, or central processing unit (CPU) 830 to process the data; transmitter units (Tx) 840 and egress ports 850 for transmitting the data; and a memory 860 for storing the data. The network device 800 may also comprise optical-to-electrical (OE) components and electrical-to-optical (EO) components coupled to the ingress ports 810, receiver units 820, transmitter units 840, and egress ports 850 for egress or ingress of optical or electrical signals.

The processor 830 may be implemented by hardware and software. The processor 830 may be implemented as one or more CPU chips, cores (e.g., as a multi-core processor), field-programmable gate arrays (FPGAs), application specific integrated circuits (ASICs), and digital signal processors (DSPs). The processor 830 is in communication with the ingress ports 810, receiver units 820, transmitter units 840, egress ports 850, and memory 860. The processor 830 comprises an OMCN module 870. The OMCN module 870 performs at least part of the methods 400, 500, 600, 700. The inclusion of the OMCN module 870 therefore provides an improvement to the functionality of the device 800. The OMCN module 870 also effects a transformation of the device 800 to a different state. Alternatively, the OMCN module 870 is implemented as instructions stored in the memory 860 and executed by the processor 830.

The memory 860 comprises one or more disks, tape drives, and solid-state drives and may be used as an over-flow data storage device, to store programs when such programs are selected for execution, and to store instructions and data that are read during program execution. The memory 860 may be volatile and non-volatile and may be read-only memory (ROM), random-access memory (RAM), ternary content-addressable memory (TCAM), and static random-access memory (SRAM).

The use of the term “about” means a range including ±10% of the subsequent number, unless otherwise stated. While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method implemented in a boundary device located in a first network, the method comprising:
receiving a first frame from a first node located in a second network;
detecting a format of the first frame, wherein the format is compatible with the first node, but is incompatible with a second node located in the first network;
converting the first frame to a second frame, wherein the second frame is in a second format that is compatible with the second node, but is incompatible with the first node; and
transmitting the second frame towards the second node.

2. The method of claim 1, wherein the first frame comprises a first destination media access control (DMAC) field, a source media access control (SMAC) field, a first EtherType (E-Type) field, a payload, and a first frame check sequence (FCS) field.

3. The method of claim 2, wherein the converting comprises:
forming a header associated with the first network; and
forming the second frame with the header and the payload.

4. The method of claim 3, wherein the forming the header comprises:
forming a destination virtual media access control (D-VMAC) field in a first header field;
forming a hop count field in a second header field;
forming a reserved field in a third header field; and
placing the first E-Type field in a fourth header field.

5. The method of claim 4, further comprising:
setting the D-VMAC field to a first value of the first DMAC field;
setting the hop count field to a predetermined maximum value N, wherein N is an integer; and
setting the reserved field to zero.

6. The method of claim 3, wherein the forming the second frame comprises:
forming a second DMAC field in a first field;
forming a source virtual media access control (S-VMAC) field in a second field;
forming a second E-Type field in a third field;
placing the header in a fourth field;
placing the payload in a fifth field; and
forming a second FCS field in a sixth field.

7. The method of claim 6, further comprising:
setting the second DMAC field to a predetermined value;
setting the S-VMAC field to a media access control (MAC) address that uniquely identifies the boundary device within the first network;
setting the second E-Type field to a second value assigned to the first network; and
setting the FCS field to a third value of a cyclic redundancy check (CRC).

8. The method of claim 1, wherein the first network is an in-band management network (IBMN) and the second network is an out-of-band management network (OBMN).

9. The method of claim 1, wherein the first network is an overlay management control network (OMCN) and the second network is a non-OMCN.

10. A method comprising:
receiving an overlay management control network (OMCN) frame from a source node located in an OMCN;
converting the OMCN frame to an Ethernet frame so that the converting is transparent to a non-OMCN; and
transmitting the Ethernet frame towards a destination node located in the non-OMCN.

11. The method of claim 10, wherein the converting comprises:
extracting an OMCN header and a payload from the OMCN frame;
extracting a destination virtual media access control (D-VMAC) field and an EtherType (E-Type) field from the OMCN header; and
forming the Ethernet frame.

12. The method of claim 11, wherein the forming comprises:
forming a destination media access control (DMAC) field in a first field of the Ethernet frame;
forming a source media access control (SMAC) field in a second field of the Ethernet frame;
placing the E-Type field in a third field of the Ethernet frame;
placing the payload in a fourth field of the Ethernet frame; and
forming a frame check sequence (FCS) field in a fifth field of the Ethernet frame.

13. The method of claim 12, further comprising:
setting the DMAC field to a first value of the D-VMAC field;
setting the SMAC field to an external media access control (EMAC) address of a boundary device located in the OMCN; and
setting the FCS field to a second value of a cyclic redundancy check (CRC).

14. The method of claim 13, wherein the method is implemented in the boundary device of the OMCN.

15. An apparatus located in a first network and comprising:
a receiver configured to:
receive, from a first source node located in the first network, a first frame associated with the first network; and
receive, from a second source node located in a second network, a second frame associated with the second network;
a processor coupled to the receiver and configured to:
convert the first frame to a third frame associated with the second network; and
convert the second frame to a fourth frame associated with the first network; and
a transmitter coupled to the processor and configured to:
transmit, towards a first destination node located in the second network, the third frame; and
transmit, towards a second destination node located in the first network, the fourth frame.

16. The apparatus of claim 15, wherein the first frame and the fourth frame are compatible with the first network, but are incompatible with the second network, and wherein the second frame and the third frame are compatible with the second network, but are incompatible with the first network.

17. The apparatus of claim 15, wherein the first network is an overlay management control network (OMCN) and the second network is a non-OMCN.

18. The apparatus of claim 15, wherein the apparatus is a switch further located in a boundary of the first network, and wherein the processor is further configured to convert all additional frames passing through the apparatus.

19. The apparatus of claim 15, wherein the third frame comprises:
a destination media access control (DMAC) field in a first field;
a source media access control (SMAC) field in a second field;
an EtherType (E-Type) field in a third field;
a payload in a fourth field; and
a frame check sequence (FCS) field in a fifth field.

20. The apparatus of claim 15, wherein the fourth frame comprises:
a destination media access control (DMAC) field in a first field;
a source virtual media access control (S-VMAC) field in a second field;
an EtherType (E-Type) field in a third field;
an overlay management control network (OMCN) header in a fourth field;
a payload in a fifth field; and
a frame check sequence (FCS) field in a sixth field.
